(19) United States
(12) Patent Application Publication
(10) Pub. No.: US 2016/0131086 A1
(43) Pub. Date: May 12, 2016

(54) Liquid Filter, Function Module, Connecting Part, Filter Element, and Filter Module of a Liquid Filter

(71) Applicant: Mann+Hummel GMBH, Ludwigsburg (DE)

(72) Inventors: Christian Thalmann, Speyer (DE); Martin Postel, Hassloch (DE); Dominic Burgstahler, Kandel (DE)

(21) Appl. No.: 14/919,879

(22) Filed: Oct. 22, 2015

(30) Foreign Application Priority Data
Nov. 11, 2014 (DE) 102014016561.2

(51) Int. Cl. F02M 19/06; B01D 35/00; B01D 35/18; B01D 35/30; B01D 35/26

(52) U.S. Cl. CPC F02M 19/066; B01D 35/306; B01D 35/26; B01D 35/18; B01D 35/005

(57) ABSTRACT

A liquid filter for liquid, a function module, a connecting part, a filter element, and a filter module of a liquid filter are described. The liquid filter includes at least one fluid passage, in particular at least one inlet for liquid to be filtered and/or at least one outlet for filtered liquid and/or at least one separation medium outlet for any medium separated from the liquid. In addition, the liquid filter has at least one filter element which separates at least one inlet from at least one outlet. Furthermore, the liquid filter has at least one replaceable function module which is fluidically connected to at least one fluid passage. At least two functionally different fluid passages, in particular at least one inlet and at least one outlet, are fluidically connected to separate function modules.

### TECHNICAL FIELD

The invention relates to a liquid filter for liquid, in particular fuel, in particular diesel fuel, in particular of an internal combustion engine, in particular of a motor vehicle, having at least one fluid passage, in particular at least one inlet for liquid to be filtered and/or at least one outlet for filtered liquid and/or at least one separation medium outlet for any medium separated from the liquid, having at least one filter element which separates at least one inlet from at least one outlet, and having at least one replaceable function module which is fluidically connected to at least one fluid passage.

The invention further relates to a function module of a liquid filter for liquid, in particular fuel, in particular diesel fuel, in particular of an internal combustion engine, in particular of a motor vehicle, which may be fluidically connected in a replaceable manner to at least one fluid passage of the liquid filter, in particular to at least one inlet for liquid to be filtered and/or to at least one outlet for filtered liquid and/or to at least one separation medium outlet for any medium separated from the liquid.

The invention further relates to a connecting part of a liquid filter for liquid, in particular fuel, in particular diesel fuel, in particular of an internal combustion engine, in particular of a motor vehicle, having at least one fluid passage, in particular at least one inlet for liquid to be filtered and/or at least one outlet for filtered liquid and/or at least one separation medium outlet for any medium separated from the liquid, to which at least one function module may be fluidically connected in a replaceable manner.

Moreover, the invention relates to a filter element of a liquid filter for liquid, in particular fuel, in particular diesel fuel, in particular of an internal combustion engine, in particular of a motor vehicle, which may be situated in the liquid filter in such a way that the filter element separates at least one inlet for liquid to be filtered from at least one outlet for filtered liquid.

Lastly, the invention relates to a filter module of a liquid filter according to the invention.

### BACKGROUND

A fuel filter having a filter housing and at least one, in particular replaceable, filter element situated therein, and connections for the fuel inlet and the fuel outlet is known from DE 103 33 168 A1. To simplify installation and maintenance of such a fuel filter, a modular design with at least one filter module containing the filter element, and a distributor module which is detachably connected to the filter module via at least one module connection for fuel to be filtered and filtered fuel, is proposed.

### SUMMARY

The object of the invention is to provide a liquid filter, a function module, a connecting part, a filter element, and a filter module of a liquid filter in which the liquid filter may be equipped with different functions with the greatest possible degree of variability. In particular, the liquid filter should be easy to service and/or install.

This object is achieved according to the invention in that at least two functionally different fluid passages, in particular at least one inlet and at least one outlet, are fluidically connected to separate function modules.

According to the invention, at least two different fluid connections are fluidically connected in each case to a separate function module. The separate function modules may be different function modules having different or similar functions or similar/the same/identical function modules. Separate function modules, in particular having different functions, in particular a heating function or a pumping function, may be freely, in particular arbitrarily, combined. In this context, “separate” means that the function modules may be combined, independently of one another, with the liquid filter. The function modules may thus be spatially separate from one another. Thus, they may also be preassembled separately from one another.

The functionally different fluid passages may advantageously be at least one inlet and at least one outlet. Alternatively or additionally, one of the fluid passages may be a separation medium outlet. A medium which is separated from the liquid to be filtered with/in the liquid filter may be discharged through the separation medium outlet. In an embodiment as a fuel filter for fuel, this may advantageously be a water outlet through which water which is separated from the fuel may be discharged from the fuel filter.

The different fluid passages may be individually connected to the appropriate function module, depending on the function and requirements. A variety of different functions may thus be easily augmented. Individual combinations of function modules may be more easily implemented to meet the particular requirements, and/or customized for the user and/or customer.

The separate function modules may be situated on the liquid filter more flexibly than combined function modules. The structural shape of the liquid filter may thus be adapted to an available installation space with greater variability.

Multiple, in particular all, function modules may advantageously be situated on one side of the liquid filter. For the liquid filter according to the invention, only one connection side is necessary. Other sides of the liquid filter do not have to have connections and/or function modules. The connection side may advantageously be situated on an end-face side of a hollow filter element, in particular a circular filter element. The liquid filter does not have to have connections and/or function modules around the periphery of the hollow filter element.

Depending on a flow direction of the liquid through the liquid filter and/or depending on the particular function of the at least one function module, at least one of the function modules may advantageously be selectively situated on the clean fluid side, i.e., downstream, or on the untreated fluid side, i.e., upstream, with respect to the at least one filter element. The liquid filter may thus be appropriately combined with the function modules for use for different flow directions.

At least one connecting section, optionally a connecting part, of the liquid filter, in particular a connection module or filter head module or a filter head, may advantageously be used for different, in particular all, variations of flow directions.

At least one sealing device, in particular a ring seal, may advantageously be situated between the at least one function module and the at least one fluid passage. The seal-tightness of the connection may be improved in this way.

At least one function module may advantageously be made, at least partially, of plastic. The function module may advantageously be implemented, at least partially, as an injection-molded part.

At least one section, in particular a connecting section, which has at least one fluid passage or at least forms part of a fluid passage may contain plastic, at least in part. The at least one section may advantageously be implemented as an injection-molded part.

The at least one filter element may advantageously have at least one filter medium for filtering the liquid. The filter medium may be filter paper, filter fleece, or some other filter medium that is suitable for filtering liquid. The filter medium may have a single layer or multiple layers. It may also be a multi-component filter medium.

The liquid filter, in particular the at least one filter element, may additionally have parts of a separation device for separating medium that may possibly be entrained in the liquid.

The liquid filter may advantageously have at least one coalescence medium with which smaller particles, in particular droplets, of the medium to be separated may be combined into larger particles, in particular drops. In particular separation of water from fuel, in particular diesel fuel, may be improved with such a coalescence medium.

Alternatively or additionally, the liquid filter may advantageously have at least one separation medium, in particular a separation tube, with which the medium to be separated, in particular water, may be separated from the liquid. The separation medium may advantageously be hydrophobic.

Alternatively or additionally, the liquid filter may advantageously have at least one deposition chamber, in particular a deposition gap, in particular in the flow direction of the liquid, upstream from at least one separation medium that may possibly be present. In the at least one deposition chamber, the separated medium may in particular be led to a collection chamber.

The collection chamber may advantageously be connected to at least one separation medium outlet, via which the separated medium may be removed from the collection chamber.

The liquid filter may advantageously be part of a fuel system of an internal combustion engine. The liquid filter may be used for cleaning fuel which is supplied to the internal combustion engine. However, the invention is not limited to a fuel filter of a fuel system of an internal combustion engine of a motor vehicle. Rather, it may also be used for other types of liquid systems of motor vehicles. The liquid filter may also be used outside the field of automotive technology, and may be used in particular in industrial engines. The liquid filter may also be used for cleaning other types of liquids, in particular water or aqueous urea solution.

In one advantageous embodiment, at least one element, in particular a fluid line connecting element and/or a fastening element, used for connecting at least one fluid passage to at least one function module may be harmonized, in particular standardized. In this way, function modules which are harmonized in terms of connection, but which may otherwise be different, may be easily connected to different fluid passages. The variability of the liquid filter may be further increased in this way.

The at least one element may advantageously be standardized. Elements which correspond to a known standard may thus be used, and/or the elements may be combined with such standardized components.

The at least one fluid line connecting element may advantageously be a passage connection section, described in greater detail below, and/or an opening, in particular an insertion opening, of at least one fluid passage.

The at least one fastening element may advantageously be a fastening section, described in greater detail below.

In another advantageous embodiment, the liquid filter may have at least one connecting part, in particular a connection module or filter head module, which may include at least one fluid passage.

The at least one connecting part may be used as a connection component between the function modules and a filter housing or a filter module of the liquid filter. The at least one connecting part may also be part of a filter housing or filter module. The at least one connecting part may thus act as a type of adapter. Different filter modules and/or correspondingly different function modules may be connected to the at least one connecting part. The variability of the liquid filter may be further increased in this way.

The at least one connecting part may advantageously contain plastic, at least in part. It may advantageously be implemented as an injection-molded part.

The at least one connecting part may advantageously be in one piece.

In another advantageous embodiment, at least one function module may have at least one connector section for connecting a liquid line, and/or at least one liquid pump, in particular a fuel pump, and/or at least one separation medium outlet and/or at least one liquid heater, in particular a fuel heater. The at least one function module may thus be variably provided with corresponding functional properties as needed.

The at least one function module may advantageously have at least one connector section for connecting a liquid line. The at least one connector section may be used as a connecting member. Appropriate liquid lines, in particular fuel lines, for feeding or discharging the liquid may be connected to the at least one connector section. On its free end facing away from the corresponding fluid passage in terms of flow, the at least one connector section may have at least one corresponding line connection, in particular a hose connection, for the corresponding liquid line. The free end may advantageously be standardized for connection to the line connection.

At least one line connection of at least one connector section may advantageously be standardized. Uniform liquid lines may thus be easily connected to the function modules via the at least one line connection. The at least one line connection may advantageously be standardized or normalized. It may in particular correspond to an SAE standard.

The at least one line connection may advantageously have a connecting piece which is removable from the remainder of the connector section. Different connecting pieces may be provided. Straight or curved, in particular knee-shaped, connecting pieces may advantageously be provided. Standardization allows different connecting pieces to be variably connected to the corresponding remainder of the connector section, in particular the free end, as needed.

At least one function module may advantageously have multiple functionally equivalent connector sections for connecting liquid lines. The connector sections may be situated on the at least one function module, and/or may lead away from same in different directions, in different ways and/or at different locations. The at least one function module, in particular depending on its use and/or placement in the corresponding liquid system, may thus be connected to the corresponding liquid line via the particular connector section that is best suited. The respective other connector section may be closed off. A closure which in particular is openable, in particular a blind cap or a blind plug, may be used for this purpose.

Alternatively or additionally, function modules having different connector sections may be provided for connecting different liquid lines. The different connector sections, in particular the line connections thereof, may differ in shape and/or diameter. Thus, liquid lines having different diameters may be connected to the same fluid passage by using the appropriate function module. The appropriate function module may thus act as a connection adapter.

Alternatively or additionally, at least one function module may have at least one liquid pump, in particular a fuel pump. The liquid, in particular fuel, may be pumped or drawn into/through the liquid filter, using the at least one liquid pump. The at least one liquid pump may be situated upstream, in terms of flow, from at least one inlet for fuel. Alternatively, the at least one liquid pump may be situated downstream, in terms of flow, from at least one outlet for the liquid.

Additionally or alternatively, for at least one liquid pump for the liquid to be filtered, an identical, similar, or other type of liquid pump, in particular a water pump, may be provided for pumping or drawing out separated medium, in particular water, from the liquid to be filtered. The alternative liquid pump may be situated downstream or upstream from at least one separation medium outlet with regard to the flow direction of the separated medium.

At least one liquid pump may be manually and/or electrically actuatable.

The at least one liquid pump may be provided for filling the liquid filter and/or the liquid line with liquid during initial operation or after the liquid line or the liquid system or the liquid filter has drained, in particular after maintenance of the liquid system. This operation may be referred to as “venting” of the liquid system, in particular the liquid filter and/or the liquid line. This is advantageous in particular when the liquid filter is used as a fuel filter, in particular for diesel fuel, in a fuel system of an internal combustion engine.

Additionally or alternatively, at least one function module may advantageously have at least one connector section for discharging the separated medium.

Alternatively or additionally, at least one function module may have at least one liquid heater, in particular a fuel heater. The at least one liquid heater may advantageously be situated upstream from at least one filter element in the direction of liquid flow. In this way, the liquid may be heated before it reaches the untreated fluid side of the at least one filter element. The flowability of the liquid may thus be improved. Any pressure loss between the untreated fluid side and the clean fluid side of the at least one filter element may be reduced in this way.

Alternatively or additionally, at least one liquid heater may be situated downstream from at least one filter element with respect to the liquid flow.

Alternatively or additionally, a liquid heater may be provided for the separated medium.

The liquid filter, in particular at least one function module, may also advantageously have more than one liquid heater, in particular two liquid heaters or a double heater.

At least one liquid pump and/or at least one liquid heater may advantageously be fixedly connected, in particular in one piece, to at least one connector section. Corresponding housing sections of at least one liquid pump and/or at least one liquid heater may advantageously be implemented in one piece by means of a casting process or injection molding process. Housing support sections may advantageously be integrally molded onto the at least one function module. Any housing sections may advantageously be made, at least partially, of plastic.

In another advantageous embodiment, at least one function module may have at least one passage connection section for fluidic connection to at least one fluid passage.

At least one passage connection section may advantageously be compatible with the at least one fluid passage.

The passage connection section may advantageously have a section which is in particular tubular. The at least one fluid passage may advantageously have at least one insertion opening which matches the tubular section. The tubular section of the passage connection section may thus be easily inserted into the at least one fluid passage. A fluid connection between the at least one function module and the at least one fluid passage may be easily achieved in this way.

Alternatively, the at least one fluid passage may have a section which is in particular tubular. Similarly, the at least one passage connection section may have a corresponding insertion opening.

The tubular section and the insertion opening may advantageously have a symmetry, in particular a circular cross section. The at least one function module may thus be connected to the at least one fluid passage in different orientations.

The tubular section and/or the insertion opening may advantageously have a conically tapering design. Connecting the at least one passage connection section and the at least one fluid passage may be simplified in this way.

At least two different fluid passages may advantageously have the same design. Similarly, the passage connection sections of at least two separate function modules may have the same design. The fluid passages and the function modules may thus be more easily combined with one another.

In another advantageous embodiment, at least one function module may have at least one fastening section, in particular a fastening flange and/or a supporting section, with which the function module may be mechanically connected to a corresponding fastening section on the filter side, in particular a connecting section and/or a support lug. The at least one function module may thus be easily mechanically connected on the filter side to a corresponding fastening section, optionally of a connecting part, in particular of a filter housing. The at least one function module may be supported on the filter side, in particular on a filter housing or a connecting section or connecting part, by means of the at least one fastening section.

The at least one function module may be fastened to the at least one fastening section on the filter side by means of a positive-fit and/or force-fit and/or material-fit connection, in particular an adhesive connection, weld connection, solder connection, clamp connection, plug-in connection, detent connection, bayonet-like connection, a connection using a screw or screws, a snap-on connection, or some other type of connection, also a combined connection.

The at least one function module may advantageously be connected to at least one fastening section on the filter side by means of a screw connection, in particular by means of self-tapping screws, in particular made of steel, or other screws which are also detachable. Screws, in particular machine screws, which may be screwed into corresponding threads may also be used.

The fastening may be detachable. This has the advantage that the at least one function module may be more easily replaced/removed.

Alternatively, the fastening may be designed so that it is not detachable without destruction. The liquid filter, at least the filter housing and the filter module, may thus be designed as a lifetime part.

At least one passage connection section and/or at least one fastening section of at least one function module, and/or a fluid passage and/or a fastening section on the filter side, may advantageously have at least one symmetry. The at least one function module may thus be installed in different orientations on the filter side, in particular on the filter housing or a filter head. In particular the at least one function module may thus be rotated relative to the corresponding fluid passage. A connector section may be displaced for a corresponding liquid line with respect to the remainder of the liquid filter. Thus, a connector section may be displaced to an opposite side by rotating the at least one function module by 180°.

In another advantageous embodiment, at least one filter element may be a hollow filter element, in particular a circular filter element. Hollow filter elements may be implemented in a space-saving manner. Hollow filter elements may be implemented with a spatial extension that is favorable in relation to their filter-active flow-through surface.

For a hollow filter element, the filter medium circumferentially surrounds at least one element inner space in an at least partially closed manner.

The filter medium may advantageously be closed or open circumferentially with respect to an element axis. The filter medium may in particular be star-shaped, preferably zigzag-shaped or wave-shaped, folded, or bent. The filter medium may also be unfolded or unbent.

The hollow filter element may in particular be a circular filter element having a circular cross section, an oval circular filter element having an oval cross section, a flattened oval circular filter element having a flattened oval cross section, a conical circular filter element in which the circular cross section tapers in the axial direction with respect to a main axis, a conical-oval circular filter element in which the oval cross section tapers in the axial direction, at least in the direction of a transverse axis, or a conical flattened oval circular filter element in which the flattened oval cross section tapers in the axial direction, at least in the direction of a transverse axis. A hollow filter element having some other type of cross section, in particular a square cross section, and/or some other type of axial cross-sectional profile in the direction of the main axis, may also be provided.

At least one fluid passage of the liquid filter may advantageously be connected to the element inner space of the hollow filter element. A corresponding functionally different fluid passage may be connected to an outer space which surrounds the hollow filter element.

Flow may pass through the hollow filter element from the outside (from the untreated fluid side) to the inside (to the clean fluid side), and to the element inner space. A fluid outlet may be connected to the element inner space. Flow may also pass through the hollow filter element from the inside to the outside.

The fluid passage connected to the element inner space may be centrally situated on an end-face side of a housing or a filter head of the liquid filter. The central fluid passage may advantageously be coaxial with respect to the element axis of the hollow filter element. The respective other fluid passage, in particular the fluid inlet, may be situated eccentrically with respect to the element axis. The corresponding function modules may thus be placed in a space-saving manner on the end-face side with respect to the hollow filter element.

In another advantageous embodiment, the liquid filter may have at least one openable filter housing in which at least one filter element may be replaceably situated. The at least one filter element may thus be easily replaced or cleaned as needed, in particular in the event of loading or soiling. These types of liquid filters may be referred to as cartridge systems.

The openable filter housing may advantageously have a housing body with an installation opening. The at least one filter element may be easily installed in the housing body through the installation opening. The installation opening of the housing body may be closed with a housing lid.

The housing lid may advantageously have at least one fluid passage, in particular at least one inlet and/or at least one outlet, for the liquid.

Alternatively or additionally, the housing body may have at least one separation medium outlet.

The housing lid may advantageously act as a filter head or be formed by same.

The housing body may advantageously be connected to the housing lid by means of a rotating/plug-in connection. The housing body may advantageously be screwed onto the housing lid by means of a screw connection.

The filter housing, in particular the housing lid and/or the housing body, may be fixedly, separably, or inseparably fastened in particular to a frame part, in particular in an engine compartment of a motor vehicle. The filter housing may have at least one mounting device for this purpose.

If only the housing lid or only the housing body is connected in particular to the frame part, the housing body may be more easily separated from the housing lid, in particular for maintenance purposes.

In another advantageous embodiment, the liquid filter may have at least one filter head which has at least one fluid passage and on which at least one filter cartridge having at least one filter element may be detachably situated in a replaceable manner.

The filter cartridge may be regarded as a filter module. The filter cartridge may have a filter housing in which at least one fixed filter element may be situated. The filter cartridge together with the at least one filter element may thus be completely replaced. These types of liquid filters may be referred to as so-called spin-on filters or replacement filters.

Corresponding different housing connecting parts or filter heads may be provided when filter modules having different connections are used. The housing connecting parts or filter heads may be compatible with other function modules, and in particular may have matching connections. Different function modules having different filter modules may be combined in this way.

The filter housing of the filter cartridge may be designed in such a way that it is not openable without destruction.

The at least one filter head may remain fixedly connected to the liquid system, in particular to a frame part of the internal combustion engine or of the motor vehicle. The filter cartridge may be easily replaced.

The filter cartridge may advantageously have at least one fluid passage which may be connected to a corresponding function module. The at least one fluid passage may advantageously be a water outlet.

The object is further achieved according to the invention with the function module, in that the function module may be fluidically connected to at least two functionally different fluid passages, in particular at least one inlet and at least one outlet.

The object is further achieved according to the invention with the connecting part, in that at least two functionally different fluid passages, in particular at least one inlet and at least one outlet, may be fluidically connected to separate function modules.

Moreover, the object is achieved according to the invention with the filter element, in that the filter element may be inserted together with a liquid filter according to the invention.

Lastly, the object is achieved according to the invention with the filter module, in that it is designed as a spin-on filter or replacement filter. The filter module may thus be completely replaced in an easy manner, in particular for maintenance purposes.

In other respects, the features and advantages discussed in conjunction with the liquid filter according to the invention, the function module according to the invention, the connecting part according to the invention, the filter element according to the invention, and the filter module according to the invention, and the respective advantageous embodiments thereof apply when considered together, or also alone. Of course, the individual features and advantages may be combined with one another, wherein further advantageous effects may result which go beyond the sum of the individual effects.

### BRIEF DESCRIPTION OF THE DRAWINGS

Further advantages, features, and particulars of the invention result from the following description, in which exemplary embodiments of the invention are explained in greater detail with respect to the drawings. Those skilled in the art will also advantageously consider the features disclosed in combination in the drawings, the description, and the claims individually, and combine them into further meaningful combinations. The drawings show the following in a schematic manner:

FIG. 1 shows an isometric illustration of a fuel filter for diesel fuel of an internal combustion engine of a motor vehicle, having a filter module, a hand pump module, and a heating module;

FIG. 2 shows a longitudinal section of the fuel filter from FIG. 1;

FIG. 3 shows a detailed view of a housing connecting part of the fuel filter from FIGS. 1 and 2;

FIG. 4 shows a detailed view of the hand pump module of the fuel filter from FIGS. 1 and 2;

FIG. 5 shows a detailed view of the heating module of the fuel filter from FIGS. 1 and 2;

FIG. 6 shows a detailed view of an electric pump module which may be used instead of the hand pump module in the fuel filter from FIGS. 1 and 2;

FIG. 7 shows a connector module which may be used instead of the hand pump module and/or the heating module in the fuel filter from FIGS. 1 and 2;

FIG. 8 shows an isometric illustration of an alternative combination of the fuel filter from FIGS. 1 and 2, in which the filter module is a spin-on filter; and

FIG. 9 shows a side view of the fuel filter from FIG. 8.

Identical components are provided with the same reference numerals in the figures.

### DETAILED DESCRIPTION

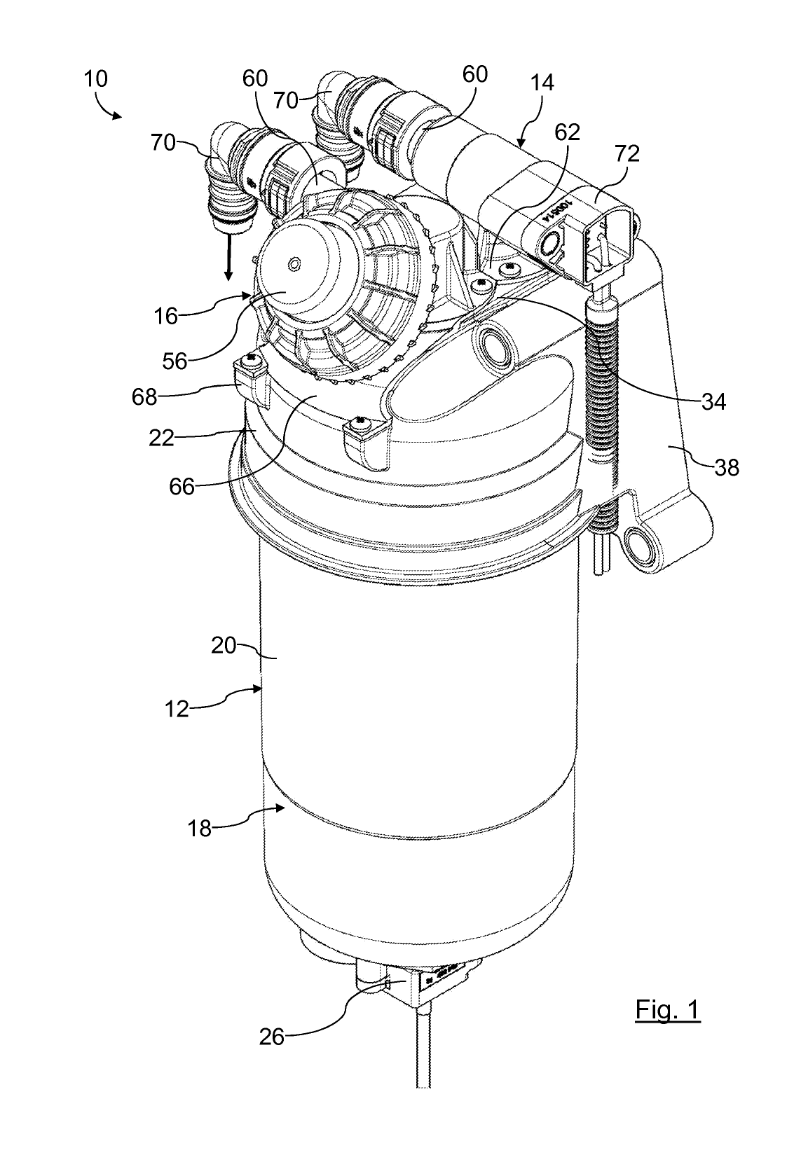

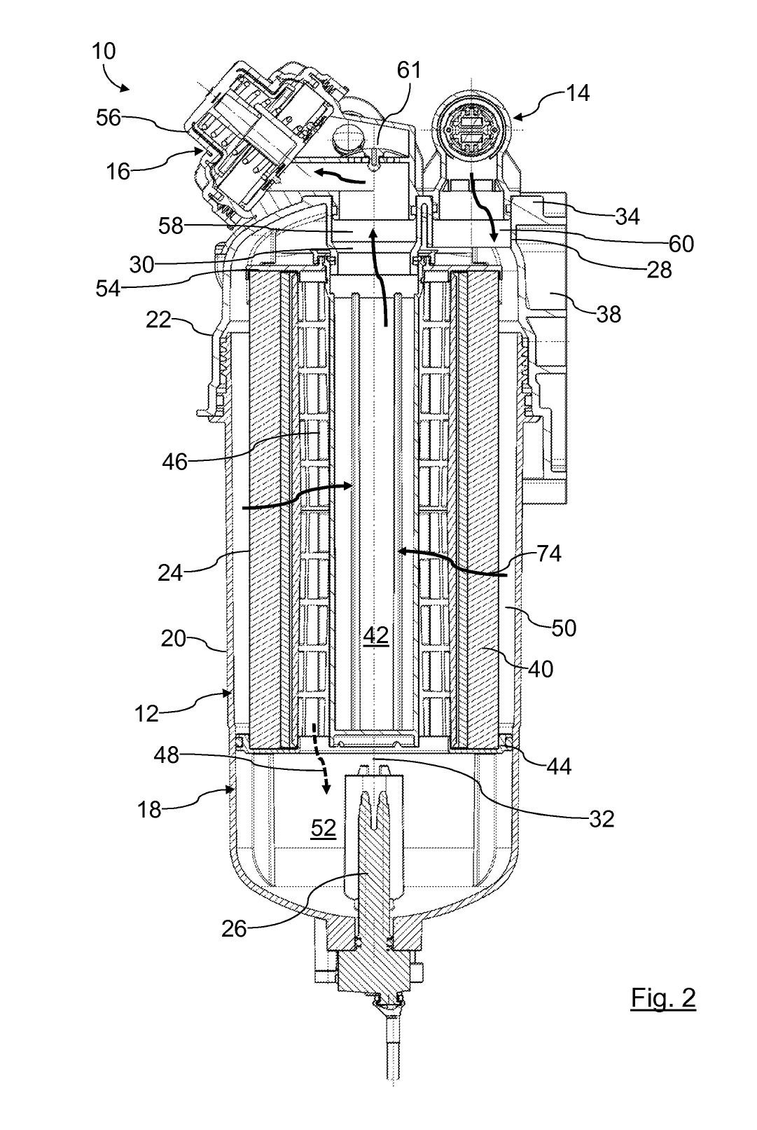

FIG. 1 shows by way of example one possible combination of a fuel filter 10 for diesel fuel of an internal combustion engine of a motor vehicle. FIG. 2 shows the fuel filter 10 in a longitudinal section. The fuel filter 10 is situated in a fuel line of the internal combustion engine.

The fuel filter 10 has a modular design overall. It includes a filter module 12, at the bottom in FIGS. 1 and 2, a heating module 14 for the diesel fuel, at the top rear in FIG. 1, and a hand pump module 16, at the top front in FIG. 1.

The filter module 12 includes a filter housing 18 having a housing body 20, at the bottom in FIGS. 1 and 2, and a housing connecting part 22, at the top in FIGS. 1 and 2.

The housing body 20 has an installation opening for a filter element 24, at the top in FIGS. 1 and 2. The housing body 20 is detachably screwed into the housing connecting part 22 from the bottom, so that the installation opening is closed off. The housing connecting part 22 is thus also used as a housing lid. In its base, at the bottom in FIGS. 1 and 2, the housing body 20 has a water discharge device 26, not of further interest here, for any water that is entrained with the fuel and separated from the fuel in the fuel filter 10.

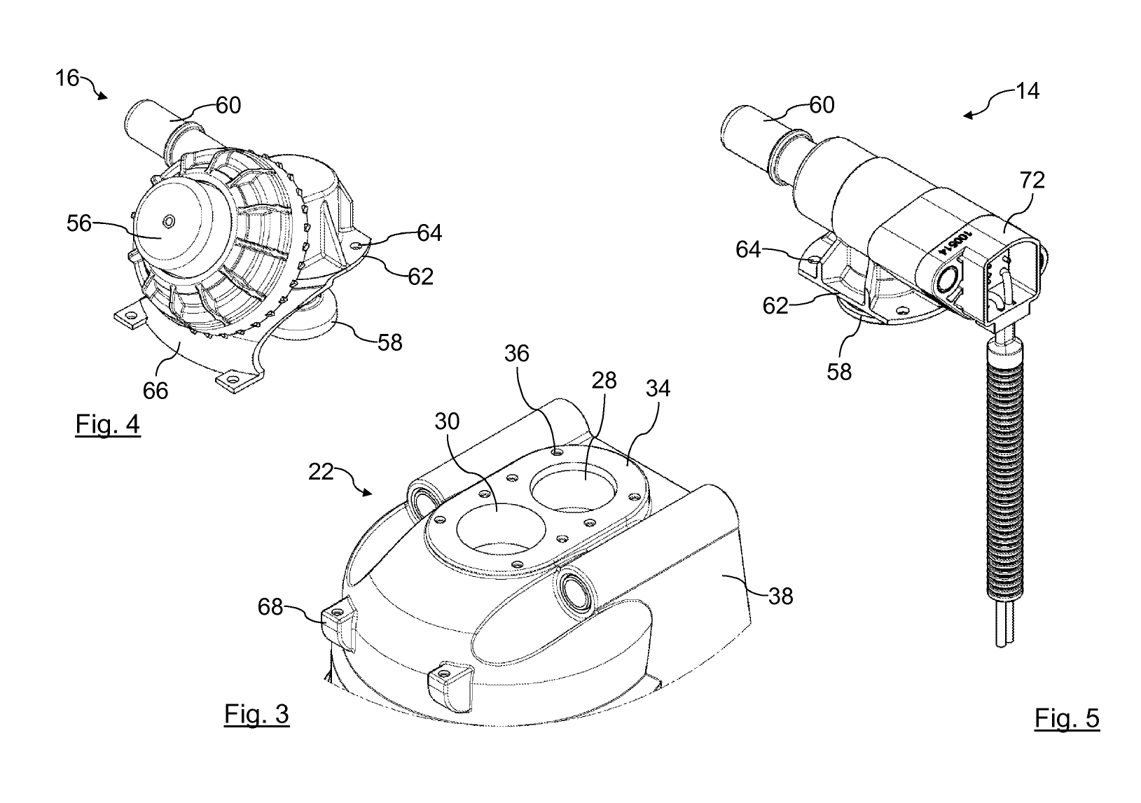

The housing connecting part 22 is shown in detail in FIG. 3. The housing connecting part 22, which may also be referred as an upper housing part or basic part, is used as a connection module for function modules, which may be combined with the fuel filter 10. In the exemplary embodiment shown, the heating module 14 and the hand pump module 16 are examples of function modules.

The housing connecting part 22 has an inlet 28 for fuel to be filtered, and an outlet 30 for filtered fuel. The outlet 30 is located in the center of the housing closing part 22, and is coaxial with respect to a filter axis 32. The inlet 28 is eccentrically situated next to the outlet 30.

In the exemplary embodiment shown, the filter axis 32 is coaxial with respect to a housing axis of the filter housing 18 and coaxial with respect to an element axis of the filter element 24. For the sake of better clarity, only the filter axis is provided with a reference numeral.

The inlet 28 and the outlet 30 are identical in shape and dimensions, and each has a circular cylindrical opening. Both the inlet 28 and the outlet 30 are therefore symmetrical with regard to their respective cylinder axis.

The inlet 28 and the outlet 30 are surrounded by a connecting section 34. The connecting section 34 has a flat surface on its outer side facing away from the housing body 20. A total of eight screw holes 36 are situated in the connecting section 34. The screw holes 36 are arranged in two groups of four. The inlet 28 and the outlet 30 are each surrounded by one of the groups of four. The four screw holes 36 of a group of four are situated at the corners of a corresponding imaginary rectangle. The two rectangles extend in parallel to one another. The distribution of the four screw holes 36 around the inlet 28 is identical to the distribution around the outlet 30. As a whole, the arrangement of the inlet 28 and of the outlet 30 with the corresponding screw holes 36 and the corresponding connecting section 34 is the same in each case. The arrangement of the inlet 28, the outlet 30, and the screw holes 36 is symmetrical with respect to itself, and as a whole, with respect to multiple axes.

In addition, the housing connecting part 22 has a mounting device 38 by means of which the fuel filter 10 may be fastened, for example to a frame part of the internal combustion engine.

The filter element 24 is designed as a so-called circular filter element. It includes a filter medium 40 which is folded in a zigzag shape and closed circumferentially with respect to the element axis. The filter medium 40 encloses an element inner space 42 circumferentially with respect to the element axis. The filter medium 40 may be a filter paper that is suitable for filtering the fuel.

On the end-face side facing the base of the housing body 20, the filter medium 40 is tightly connected to a bottom end plate 44. The bottom end plate 44 is designed as an annular plate. It has a central discharge opening for water, which may be separated from the fuel by means of a separation device 46 of the filter element 24. The flow of water through the discharge opening is indicated by a dashed-line arrow 48 in FIG. 2.

The radially outer peripheral side of the bottom end plate 44 rests closely against the radially inner peripheral side of the housing body 20, with a ring seal in between. The bottom end plate 44 separates a clean-side inlet annular space 50, which radially outwardly encloses the filter element 24, from a water collection chamber 52 at the base of the housing body 20.

On its end-face side facing the housing connecting part 22, the filter medium 40 is tightly connected to a top end plate 54. The top end plate 54 has a central outlet opening into which a cylindrical connecting piece of the housing connecting part 22 is inserted. The connecting piece is coaxial with respect to the housing axis and with respect to the element axis. The connecting piece is fluidically connected to the outlet 30.

A fluid-permeable, lattice-like support tube extends in the element inner space 42 between the end plates 44 and 54, coaxially with respect to the element axis.

A coalescence medium of the separation device 46, not of further interest here, with which the smallest water droplets entrained in the fuel may be combined into larger water drops is situated radially outside the support tube.

A fuel-permeable, hydrophobic separation tube of the separation device 46 is situated radially inside the support tube. The separation tube is likewise coaxial with respect to the element axis.

A ring-shaped deposition gap situated circumferentially with respect to the element axis is located between the coalescence medium and the peripheral wall of the separation tube. The deposition gap is connected to the water collection chamber 52 by means of the central discharge opening in the bottom end plate 44.

Water drops contained in the fuel are retained at the peripheral wall of the separation tube. The retained water drops fall into the deposition gap through the discharge opening in the bottom end plate 44 and into the water collection chamber 52.

The end-face side of the separation tube, which faces the bottom end plate 44, is closed. The end-face side facing the top end plate 54 is open, and is connected to the inner space of the connecting piece, and via same, to the outlet 30 of the housing connecting part 22.

The filter element 24 is replaceably situated in the filter housing 18 in such a way that the filter element separates the inlet 28 from the outlet 30.

The hand pump module 16 is shown in detail in FIG. 4. It includes a hand pump 56 for fuel, a passage connection section 58, and a connector section 60.

The hand pump 56 is designed as a manually actuatable, spring-pretensioned diaphragm pump.

The passage connection section 58 is a circular cylindrical tube section whose radially outer diameter corresponds to the radially inner diameter of the outlet 30 and of the inlet 28. The passage connection section 58 protrudes into the outlet 30 when the fuel filter 10 is installed. An inner space of the passage connection section 58 is fluidically connected to an inlet side of the hand pump 56. The passage connection section 58 is standardized, and once again is situated at the heating module 14.

The passage connection section 58 is surrounded by a fastening flange 62 of the hand pump module 16, the fastening flange 62 being set back at the rear, viewed from the housing connecting part 22. The fastening flange 62 is flat on its side facing the housing connecting part 22. The fastening flange matches the connecting section 34 of the housing connecting part 22. In addition, the fastening flange 62 has four screw holes 64, which in their arrangement correspond to a respective group of four of the screw holes 36 of the connecting section 34. The screw holes 64 are situated symmetrically at the corners of a rectangle. The fastening flange 62 and the screw holes 64 are standardized, and once again are situated in the heating module 14.

In addition, the hand pump module 16 has a supporting section 66 with which the hand pump module 16 may be supported on corresponding support lugs 68 of the housing connecting part 22. The supporting section 66 is situated on the side of the hand pump 56. The supporting section 66 has two additional screw holes for connecting screws for the support lugs 68.

The connector section 60 has the shape of a tube section, and leads radially laterally out of the hand pump module 16 with respect to an axis of the passage connection section 58. An axis of the connector section 60 thus extends approximately perpendicularly with respect to the axis of the passage connection section 58. The free end of the connector section 60 has a standardized shape and size. It is used for connecting a standard hose connection 70. The hose connection 70 is designed by way of example as a knee piece, and is shown in FIG. 1. A corresponding fuel line of the fuel system may be connected to the hose connection 70. The connector section 60 at the standardized free end is once again similarly situated in the heating module 14.

The other end of the connector section 60 is fluidically connected to an outlet side of the hand pump 56, and is connected to the inner space of the passage connection section 58 via a check valve 61 in the form of an umbrella valve.

The passage connection section 58, the connector section 60, the fastening flange 62, the supporting section 66, and a housing section of the hand pump 56 are produced in one piece from plastic according to an injection molding process.

The heating module 14 is shown in detail in FIG. 5. The heating module 14, analogously to the hand pump module 16, includes a passage connection section 58, a connector section 60, and a fastening flange 62 having screw holes 64.

In addition, the heating module 14 includes an electric diesel heater 72 for heating the diesel fuel. The inner spaces of the passage connection section 58 and of the connector section 60 are each fluidically connected to a heating chamber of the diesel heater 72.

For installing the fuel filter 10, the hand pump module 16 with the passage connection section 58 is inserted into the outlet 30 of the housing connecting part 22. The hand pump module 16 is situated in such a way that the hand pump 56 is located on the side of the housing connecting part 22 facing away from the inlet 28. Four self-tapping steel screws are each inserted through the corresponding screw holes 64 and screwed into the screw holes 36. In addition, corresponding self-tapping steel screws are inserted through the corresponding screw holes in the supporting section 66 and screwed into the screw holes in the support lugs 68.

The heating module 14 is inserted with its passage connection section 58 into the inlet 28. The heating module 14 is oriented in such a way that, for example, the connector section 60 faces in the same direction as the connector section 60 of the hand pump module 16. The heating module 14 may also be situated rotated by 180° about the axis of the passage connection section 58, so that the connector section 60 faces the opposite direction. Self-tapping steel screws are inserted through the screw holes 64 and screwed into the corresponding screw holes 36.

The steps for installing the fuel filter 10 may be carried out in some other sequence. For example, it is possible to first connect the heating module 14, and then the hand pump module 16, to the housing connecting part 22. In addition, all steel screws may be screwed in at the end.

The hose connections 70 are connected to the connector sections 60. The hose connections 70 may instead be preassembled.

The filter element 24 is inserted, with the bottom end plate 44 leading, into the housing body 20, coaxially with respect to the filter axis 32. The housing body 20 together with the filter element 24 is screwed into the housing connecting part 22 from below, the connecting piece of the housing connecting part 22 being inserted through the central opening in the top end plate 54. The filter module 12 together with the housing body 20, the housing connecting part 22, and the filter element 24 situated therein may also be preassembled.

The completely installed fuel filter 10 is fastened to the frame part of the internal combustion engine by means of the mounting device 38. The corresponding fuel lines are connected to the hose connections 70.

For initial operation of the fuel filter 10, fuel is drawn through the fuel line, the hose connection 70, and the connector section 60 of the heating module 14 and into the fuel filter 10 by actuating the hand pump 56. The fuel to be filtered passes through the passage connection section 58 and the inlet 28 in the inlet annular space 50 on the untreated side. From there, the fuel is drawn through the filter medium 40 and into the element inner space 42. From the element inner space 42, the fuel passes through the outlet 30 and the passage connection section 58 to the inlet side of the hand pump 46. Downstream from the hand pump 46, the fuel passes into the connector section 60, and from there into the appropriate fuel line. With the fuel filter 10 initially empty, for example during initial operation, the fuel filter 10 may thus be prefilled by means of the hand pump 56 after the fuel system has been drained, or after maintenance of the fuel system or the internal combustion engine.

During operation of the internal combustion engine as well as during initial operation of the fuel filter 10, the fuel flows into the inlet annular space 50 as described above. The fuel flow through the fuel filter 10 is indicated by arrows 74 in FIG. 2. From the inlet annular space 50, the fuel to be filtered flows from radially outwardly to radially inwardly through the filter medium 40 and the coalescence medium, into the deposition gap in the element inner space 42. The fuel filter is filtered using the filter medium 40. The filtered fuel flows through the peripheral wall of the separation tube from radially outwardly to radially inwardly. The filtered fuel passes through the outlet 30 and the passage connection section 58 and into the hand pump module 16.

The cleaned fuel passes through the check valve 61 and into the connector section 60 of the hand pump module 16, and via the hand pump module and the corresponding hose connection 70 passes into the appropriate fuel line.

Any water contained in the fuel is retained by the separation tube, and falls downwardly into the deposition gap, through the corresponding central discharge opening in the bottom end plate 44, and into the water collection chamber 52. The collected water may be discharged from the water collection chamber by means of the water discharge device 26.

During operation of the internal combustion engine, the fuel supplied to the fuel filter 10 may be heated if necessary, in particular as a function of the temperature of the fuel, by means of the heating module 14. The flowability of the fuel may be improved in this way.

For maintenance purposes, the housing body 20 may be unscrewed from the housing connecting part 22, and the filter element 24 may be replaced.

An electric pump module 116 is shown in FIG. 6. In the fuel filter 10 from FIGS. 1 and 2, the electric pump module 116 instead of the hand pump module 16 may be combined with the housing connecting part 22. The electric pump module 116 has an electric pump 156 instead of the hand pump 56.

In contrast to the hand pump module 16, the electric pump module 116 has two connector sections 60. The free ends of the connector sections 60 are standardized. They correspond to the free ends of the connector sections 60 of the hand pump module 16 and of the heating module 14. The connector sections 60 lead out from the electric pump module 116 on opposite sides. The axes of the two connector sections 60 are coaxial. The connector sections 60 are fluidically connected to one another within the electric pump module 116. One of the connector sections 60 may optionally be connected to the corresponding line section of the fuel line. The other, unneeded connector section 60 may be closed off with a blind plug.

In other respects, the electric pump module 116, analogously to the hand pump module 16, has a passage connection section, a fastening flange with screw holes (concealed in FIG. 6), and a supporting section 66. The passage connection section, the fastening flange with the screw holes, and the supporting section 66 are standardized. They correspond to the respective fastening flange 62 with screw holes 64, the respective passage connection section 58, and optionally the supporting section 66 of the hand pump module 16 and of the heating module 14.

The connector sections 60, the passage connection section, the fastening flange, the supporting section, and a corresponding housing part of the electric pump 156 are produced in one piece from plastic by means of an injection molding process.

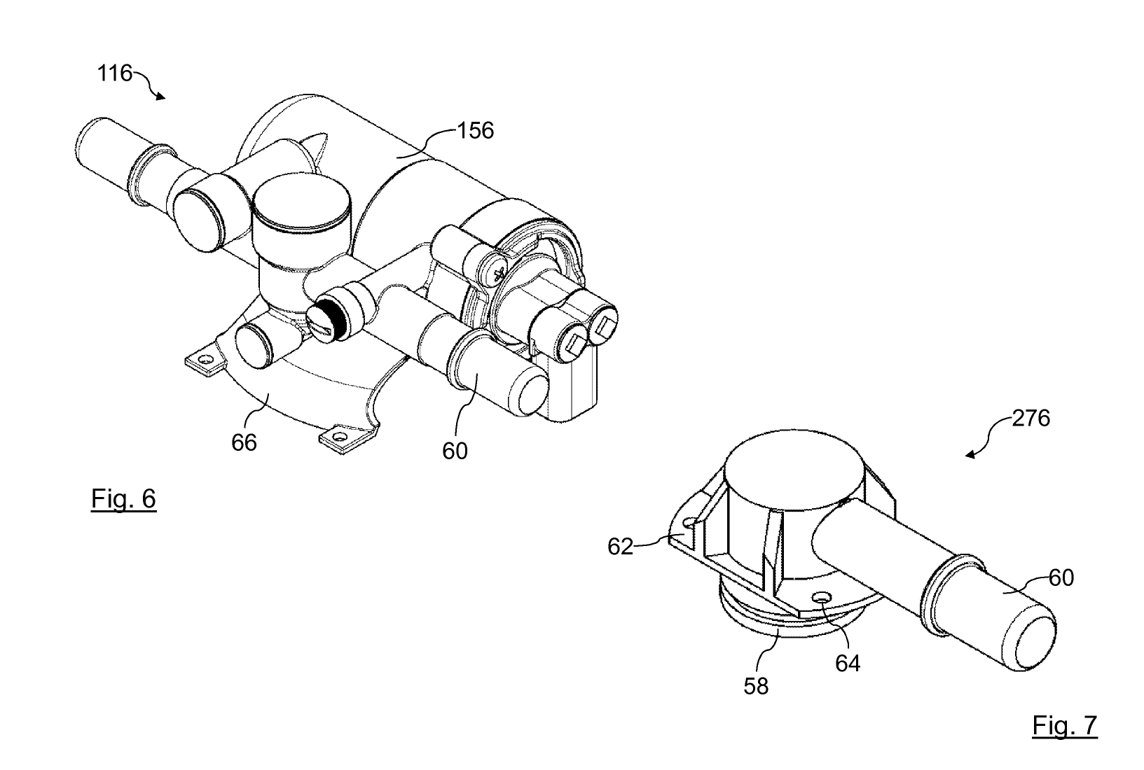

FIG. 7 shows a connector module 276, which may be used instead of the heating module 14 and/or the hand pump module 16 in the fuel filter 10 from FIGS. 1 and 2.

The connector module 276 includes a connector section 60, a passage connection section 58, and a fastening flange 62 with screw holes 64, which are each standardized and correspondingly situated analogously to the passage connection sections 58, the connector sections 60, and the fastening flanges 62 of the heating module 14, the hand pump module 16, and the electric pump module 116.

The connector module 176 may be situated in various rotational orientations relative to an axis of the passage connection section 58, which by way of example is coaxial with respect to the filter axis 32 and with respect to the axis of the inlet 28 of the housing connecting part 22.

As a whole, the fuel filter 10 may be equipped with two function modules as needed, namely, by way of example the heating module 14, the hand pump module 16, the electric pump module 116, and/or the connector module 276.

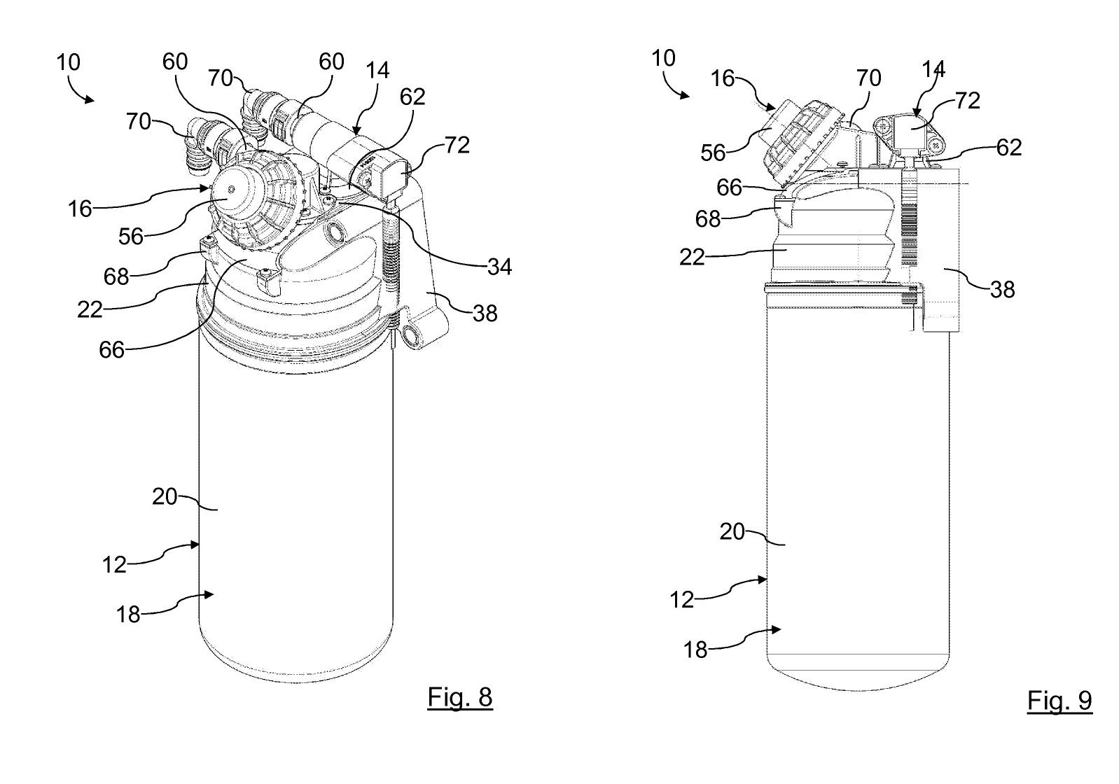

FIGS. 8 and 9 show an alternative combination of the fuel filter 10 from FIGS. 1 through 5. In FIGS. 8 and 9, the filter module 12 is designed as a so-called spin-on filter or replacement filter. With the spin-on filter, a water discharge device is dispensed with. Alternatively, the spin-on filter as a filter module 12 may be combined with the heating module 14, the hand pump module 16, the housing connecting part 22, the electric pump module 116, and/or the connector module 276.

When filter modules are used with other connections, a corresponding other housing connecting part may be provided. The other housing connecting part may have compatible connections to the heating module 14, the hand pump module 16, the electric pump module 116, and/or the connector module 276, so that these may also be connected to other filter modules.

What is claimed is:

1. Liquid filter for fuel, comprising:
at least one inlet for liquid to be filtered;
at least one outlet for filtered liquid;
at least one separation medium outlet for any medium separated from the liquid;
at least one filter element filtering the liquid and which separates at least one inlet from at least one outlet;
at least one replaceable function module which is fluidically connected to the at least one inlet and/or the at least one outlet;
wherein the at least one inlet and at least one outlet are fluidically connected to separate function modules.

2. The liquid filter according to claim 1, wherein
at least one fluid line connecting element and/or a fastening element, connecting the at least one inlet or at least one outlet to at least one function module is standardized.

3. The liquid filter according to claim 1, wherein
the liquid filter includes a connection module or filter head module which includes at least one at least one inlet or at least one outlet.

4. The liquid filter according to claim 1, wherein
the at least one function module has at least one connector section for connecting a liquid line, and/or at least one liquid pump, and/or at least one separation medium outlet and/or at least one liquid heater.

5. The liquid filter according to claim 1, wherein
the at least one function module has at least one passage connection section for fluidic connection to at least one fluid passage.

6. The liquid filter according to claim 1, wherein
the at least one function module has a fastening flange and/or a supporting section with which the function module is mechanically connected to a connecting section and/or a support lug on a side of the liquid filter.

7. The liquid filter according to claim 1, wherein
the at least one filter element is a hollow filter element.

8. The liquid filter according to claim 1, wherein
the liquid filter has an one openable filter housing within which at least one filter element is replaceably situated.

9. The liquid filter according to claim 1, wherein
the liquid filter has at least one filter head which has at least one fluid passage and on which at least one filter cartridge having at least one filter element is detachably situated in a replaceable manner.

10. A function module of a liquid filter according to claim 1, wherein
the function module is configured to be fluidically connected in a replaceable manner to at least one inlet for liquid to be filtered and/or to at least one outlet for filtered liquid of the liquid filter and/or to at least one separation medium outlet for any medium separated from the liquid;
wherein the function module may be fluidically connected to the at least one inlet and/or the at least one outlet.

11. A connecting part of a liquid filter according to claim 1, wherein
the liquid filter has at least one inlet for liquid to be filtered; and/or
at least one outlet for filtered liquid; and/or
at least one separation medium outlet for any medium separated from the liquid to which at least one function module may be fluidically connected in a replaceable manner;
wherein the at least one inlet and the at least one outlet may be fluidically connected to separate function modules.

12. A filter element of a liquid filter for liquid according to claim 1, wherein
the filter element is configured to be arranged within the liquid filter in such a way that the filter element separates at least one inlet for liquid to be filtered from at least one outlet for filtered liquid.
